(19) United States
(12) Patent Application Publication
(10) Pub. No.: US 2012/0087753 A1
(43) Pub. Date: Apr. 12, 2012

(54) DRILL AND CUTTING METHOD USING SAME

(75) Inventors: Hideaki KATAOKA, Higashiomi-shi (JP); Satoshi ARIMA, Higashiomi (JP); Yoshifumi KOIKE, Higashiomi (JP); Wataru AOKI, Nagoya (JP)

(73) Assignee: KYOCERA CORPORATION, Kyoto (JP)

(21) Appl. No.: 13/207,317

(22) Filed: Aug. 10, 2011

(30) Foreign Application Priority Data
Jan. 29, 2009 (JP) JP2009-17922

(51) Int. Cl. B23B 51/02; B23B 35/00

(52) U.S. Cl. 408/1 R; 408/230

(57) ABSTRACT

A drill includes a plurality of cutting edges formed at a front end portion; twisted flutes which are formed on an outer periphery from rear end portions of the cutting edges, respectively, and are configured to discharge chips produced by the cutting edges; and rake faces formed between the cutting edges and ends of the twisted flutes closer to the cutting edges, respectively, wherein the rake faces each includes a first face having a width from a corresponding one of the cutting edges decreasing as the first face approaches the outer periphery from an axis; and a second face located closer to the outer periphery than the first face, and having a width from the one of the cutting edges increasing as the second face approaches the outer periphery from the axis, a part of the twisted flute being formed between the first face and the second face.

### TECHNICAL FIELD

The present invention relates to a drill and a cutting method using the drill.

### BACKGROUND ART

A three-edge drill has advantages such as excellent circularity in boring and little vibration (chattering) during operation in comparison with a two-edge drill. Therefore, the three-edge drill is frequently used in boring in a case where, in particular, there is a lower hole. Japanese Unexamined Patent Publication No. 5-301108, for example, discloses the use of a three-edge drill in boring a hole in a soft material such as aluminum.

On the other hand, the three-edge drill has a narrower space of each chip discharge flute in comparison with a two-edge drill, and therefore, produced chips may rampage inside of the flutes, to damage a bored surface. Therefore, a surface needs to be reamed after boring in machining a part requiring a finished surface of a high quality, in particular, thereby increasing a machining cost.

### SUMMARY OF THE INVENTION

A main object of the present invention is to provide a drill which can achieve excellent circularity and obtain a favorable finished surface even without additional reaming.

Another object of the present invention is to provide a cutting method using the drill.

A drill according to an embodiment of the present invention includes a plurality of cutting edges formed at a front end portion; twisted flutes which are formed on an outer periphery from rear end portions of the cutting edges, respectively, and are configured to discharge chips produced by the cutting edges; and rake faces formed between the cutting edges and ends of the twisted flutes closer to the cutting edges, respectively, wherein the rake faces each includes a first face having a width from a corresponding one of the cutting edges decreasing as the first face approaches the outer periphery from an axis; and a second face located closer to the outer periphery than the first face, and having a width from the one of the cutting edges increasing as the second face approaches the outer periphery from the axis.

A method of cutting a workpiece for boring with the drill according to the embodiment of the present invention includes the step of approaching a drill and a workpiece each other while rotating the drill; bringing the cutting edges of the drill into contact with a surface of the workpiece, and boring the workpiece; and separating the workpiece and the drill from each other.

In the drill according to the embodiment of the present invention, the twisted flutes each is formed between the first face closer to an axis, constituting the rake face, and the second face closer to the outer periphery, respectively, in such a manner as to project toward the cutting edges. Consequently, when the chips produced by the cutting edges are fed to a certain degree, they pass both the rake faces and the projecting portions of the twisted flutes at the same time. At this time, a portion of the chips passing the faces of the twisted flutes is deformed (that is, curved) in conformity with the shape of the faces of the twisted flutes. Therefore, the chips become smaller than the width of the cutting edges (that is, some of the chips are squeezed), thereby reducing a damage on an inner wall of the workpiece, which has been conventionally caused by the chips. Thus, the favorable finished face can be obtained.

### BRIEF DESCRIPTION OF THE DRAWINGS

FIG. 1 is a side view showing a drill 1 in an embodiment of the present invention;

FIG. 2 is a view showing the drill, as viewed from the front in FIG. 1;

FIG. 3 is a view showing the drill, as viewed in a direction X in FIG. 2;

FIG. 4 is a view showing the drill, as viewed in a direction Y in FIG. 2; and

FIG. 5 is an enlarged view showing essential parts shown in FIG. 3.

### DETAILED DESCRIPTION OF THE INVENTION

A detailed description will be given below according to an embodiment of the present invention with reference to the attached drawings.

### <Drill>

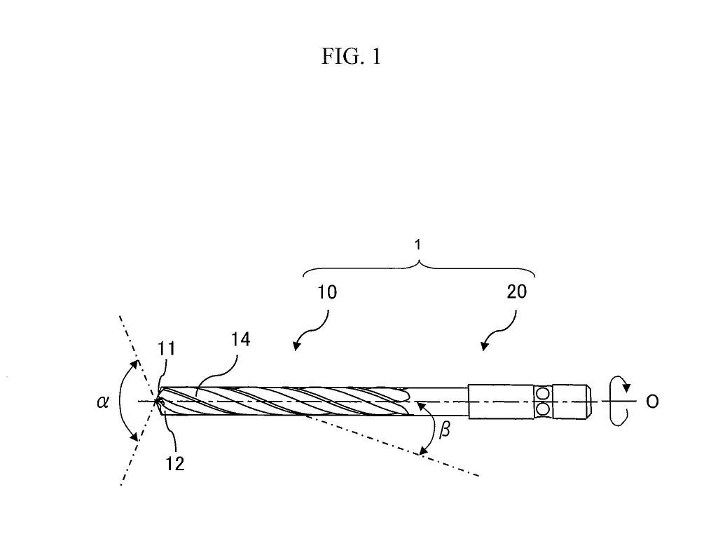

In FIG. 1, a drill 1 is formed into a substantially columnar shape centering an axis O, and includes a cutting portion 10, which comes into contact with a workpiece and a shank portion 20 to be gripped on a rotary shaft of a machine tool.

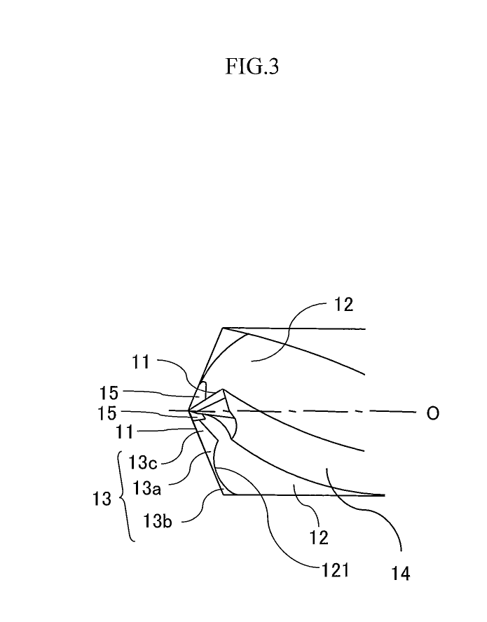

The cutting portion 10 has a plurality of cutting edges 11 formed at the front end thereof and twisted flutes 12 for discharging chips produced by the cutting edges 11 formed at the outer periphery thereof. Moreover, a rake faces 13 are formed between the cutting edges 11 and ends of the twisted flutes 12 closer to the cutting edges, as shown in FIG. 3.

A front-end angle α at the front end of the cutting portion 10 may be appropriately set by taking biting of the cutting edges and operability of the drill into consideration. In the case of a three-edge drill like in the present embodiment, the front-end α ranges from 100° to 135°, more preferably, 110° to 130°. In the present embodiment, the front-end angle α is set to 120°. In this case, the drill can be prevented from chattering and can be improved in biting.

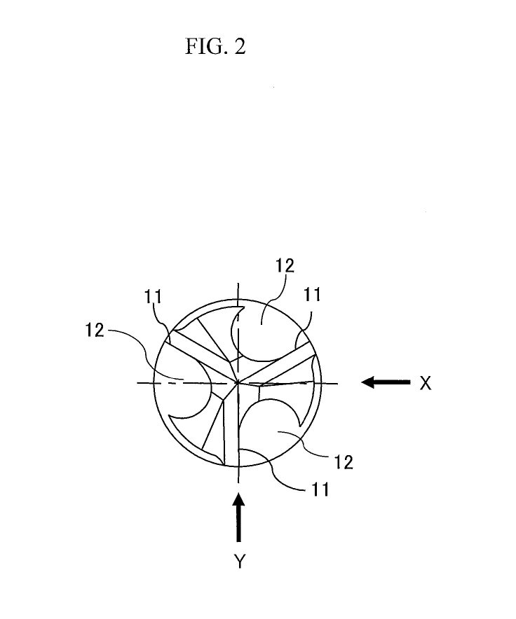

The plurality of cutting edges 11 are provided according to the use purpose of the drill in such a manner as to rotationally symmetric with respect to the axis O. For example, in the case of a hand drill or the like, the number of cutting edges should be preferably greater in consideration of operability. A three-edge drill having three cutting edges 11 is shown in the present embodiment, as shown in FIG. 2. The cutting edges 11 are rotationally symmetric with each other at 120° with respect to the axis O.

The twisted flute 12 is formed in each of the cutting edges 11 in order to discharge chips produced by the cutting edges. The twisted flutes 12 are formed on the outer periphery such that they are twisted at an angle β (a twist angle) with respect to the axis O toward the rear end in the direction of the axis O. The twist angle β should preferably range from 10° to 45°, more preferably, range from 20° to 30°. In the present embodiment, the twist angle β is 24°. Incidentally, lands 14 are formed at the outer periphery of the cutting portion 10, at which no twisted flutes 12 are formed. The lands 14 also are formed in such a manner as to be twisted at the twist angle β in the same manner as the twisted flutes 12.

Projecting ends 121 are formed at the ends closer to the cutting edges in the twisted flutes 12 in such a manner as to approach nearest the cutting edges 11. In other words, the projecting ends 121 are formed such that the rake faces 13 are located both on the axis O side and the outer peripheral side. Here, the projecting ends 121 may be brought into contact with the cutting edges 11. In the projecting ends 121, when the chips produced by the cutting edges 11 are fed, at the same time when some of the chips pass the projecting ends 121 whereas the remainder of the chips passes the rake faces 13. With this configuration, the rake faces 13 stably keep the chip discharge direction (that is, a feed direction) while some of the chips can be deformed (bent) along the faces of the twisted flutes 12 at the twisted flutes in the vicinity of the projecting ends 121. The resultant deformed chips become smaller than the cutting edges 11, and further, the end of the chip is bent inward, thereby reducing damage at a finished surface by the end of the chip so as to obtain an excellent finished surface.

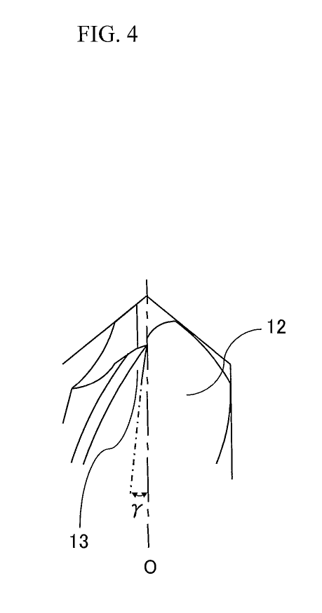

The rake faces 13 are formed between the cutting edges 11 and the ends of the twisted flutes 12 closer to the cutting edges, as shown in FIG. 3. As described above, the rake faces 13 have the function of stabilizing the chip discharge direction when the chips are deformed in the twisted flutes 12. The rake faces 13 are formed in such a manner as to define a positive rake angle γ with respect to the axis O, as shown in FIG. 4. The rake angle γ is not particularly restricted as long as it is smaller than the twist angle β of the twisted flutes 12. For example, in the case of the three-edge drill in the present embodiment, the rake angle γ should be preferably 8° or more, preferably should range from 8° to 20°, more preferably, 8° to 15° from the viewpoints of small vibration during boring by the drill and excellent operability. The rake angle γ is 10° in the present embodiment.

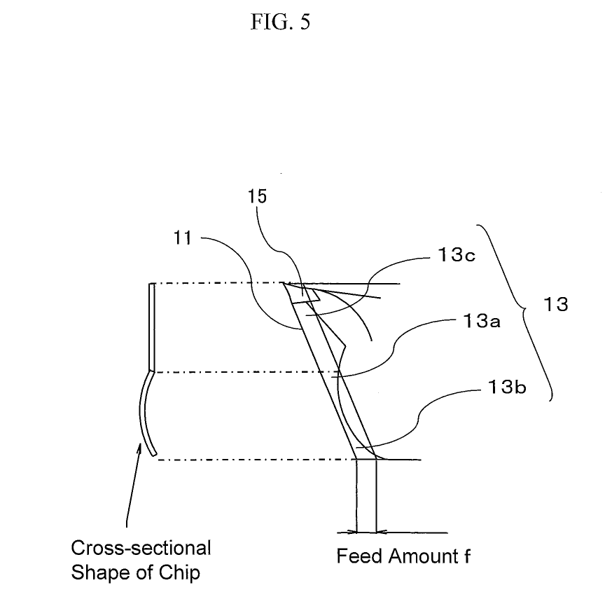

The rake faces 13 each includes a first face 13a having a width from one of the cutting edges 11 decreasing as the first face 13a approaches the outer periphery from an axis O, and a second face 13b which is located closer to the outer periphery than the first face 13a, and having a width from the one of the cutting edges increasing as the second face approaches the outer periphery from the axis O. With this configuration, the twisted flutes 12 (the projecting ends 121 of the twisted flutes) are formed between the first faces 13a and the second faces 13b, respectively. In other words, the first face, a surface of one of the twisted flutes, and the second face are formed in this order toward the outer periphery from the axis at a position apart by a predetermined distance from the cutting edge 11 along the rake face 13. For example, as shown in FIG. 5, the first face 13a, the surface of one of the twisted flutes 12, and the second face 13b are configured in this order from the axis O toward the outer periphery with respect to the tip position of the chip assuming that feed amount by the drill is designated by f. At this position, the chips are fed along the rake faces at a portion in contact with the rake faces 13 whereas a portion in contact with the twisted flutes 12 are forcibly deformed by the above-described function. Specifically, a chip has a partly deformed cross-sectional shape shown in FIG. 5.

The second face 13b should be preferably formed into a substantially triangular shape as one of the rake faces 13 is viewed in the front, as shown in FIG. 3. Since a larger force is exerted on the outer peripheral side of the cutting portion 10 when the chip is deformed, damage is liable to occur in the vicinity of the outer periphery. However, in the present embodiment, the second face 13b is formed into a substantially triangular shape in such a manner as to be gradually enlarged from the axis toward the outer periphery, and therefore, concentration of a stress can be alleviated, thus suppressing the above-described damage in the vicinity of the outer periphery of the cutting portion 10. In particular, in the case of a drill having narrow flutes width like the three-edge drill, a greater deformation function is needed. Consequently, the formation of the second face 13b into a substantially triangular shape is markedly effective in suppressing a damage in the vicinity of the outer periphery of the cutting portion 10.

The first face 13a and the second face 13b may be continuously connected to or separated from each other. Although a boundary portion between the first face 13a and the second face 13b or a nearest portion when they are separated is not particularly limited, it should be preferably formed on, for example, the outer periphery beyond the center point of the cutting edges 11 from the viewpoint of excellent deformation of the chip.

Moreover, one boundary between the first face 13a and one of the twisted flutes 12 and another boundary between the second face 13b and the one of the twisted flutes 12 should be preferably curved toward the cutting edges 11, as one of the rake faces 13 is viewed in the front. Here, the boundaries should be preferably symmetrical with each other in a lateral direction.

In addition to the first face 13a and the second face 13b at each rake face 13 in the present embodiment, there is a third face 13c which is located continuously closer to the axis O than the first face 13a and has a width from the one of the cutting edges increasing as the third face 13c approaches the outer periphery from the axis O.

Additionally, in the present embodiment, thinning faces 15 are formed at the front end of the drill in such a manner as to cross each other on the axis O, as shown in FIG. 3. The peripheral end of the thinning face 15 is connected to one of the rake faces 13. In other embodiments, the third face of the rake face may be used as the thinning face.

The drill having the above configuration is used such that the shank portion 11 formed at the rear end of the cutting portion 10 is inserted into a drill holder in a machine tool. Any machine tools normally used by one skilled in the art may be used as the above machine tool without any limitation. For example, there may be used various machines such as a hand drill and a machining center. When a hand drill, in particularly, is used, an operator can readily perform manual feeding control with excellent operability. The drill mounted on such a machine tool is rotated on the axis O and fed toward the front end in the direction of the axis O, and then, is pressed against, for example, a workpiece, thus forming a machining hole having a predetermined inner diameter on the workpiece. The workpiece is made of, for example, a laminated material of CFPR and an aluminum alloy. Particularly, when the drill in the present embodiment is used for the laminated material of CFPR and an aluminum alloy, it is possible to obtain excellent circularity and favorable finished face with good operability.

### <Cutting Method>

In a cutting method according to the embodiment of the present invention, a workpiece is bored by using the drill having the above-described configuration. The method includes the steps of approaching a drill and a workpiece each other while rotating the drill; bringing the cutting edges of the drill into contact with a surface of the workpiece, and boring the workpiece; and separating the workpiece and the drill from each other. The workpiece to be used in the cutting method is exemplified by a workpiece made of a laminated material of CFPR and an aluminum alloy, a titanium alloy, and the like.

In the step of approaching the drill and the workpiece each other, the workpiece is mounted on a table of a machine tool having the drill 1 fixed thereto, and then, the drill 1 is allowed to approach the workpiece while being rotated. The drill 1 is enough to relatively approach the workpiece, and therefore, the workpiece may be allowed to approach the drill 1.

Subsequently, the cutting edge of the drill is brought into contact with a desired position at the surface of the workpiece, and then, bores it. Finally, the drill 1 is separated from the workpiece.

When a plurality of holes is bored in one workpiece, the above-described steps are repeated.

Although the embodiment of the present invention has been illustratively described above, the present invention is not restricted to the embodiment. It is to be understood that the present invention should be applied to any embodiments as long as it is not departed from the object of the invention.

What is claimed is:

1. A drill, comprising:
a plurality of cutting edges formed at a front end portion;
twisted flutes which are formed on an outer periphery from rear end portions of the cutting edges, respectively, and are configured to discharge chips produced by the cutting edges; and
rake faces formed between the cutting edges and ends of the twisted flutes which are closer to the cutting edges, respectively,
wherein the rake faces each comprises:
a first face having a width from a corresponding one of the cutting edges decreasing as the first face approaches the outer periphery from an axis; and
a second face located closer to the outer periphery than the first face, and having a width from the one of the cutting edges increasing as the second face approaches the outer periphery from the axis.

2. The drill according to claim 1, wherein the first face, a surface of a corresponding one of the twisted flutes, and the second face are formed in this order along the rake face in a direction from the axis toward the outer periphery, at a position apart from the cutting edges by a predetermined distance.

3. The drill according to claim 1, wherein a boundary portion or a nearest portion between the first face and the second face is located closer to the outer periphery than a center point of the one of the cutting edges.

4. The drill according to claim 1, wherein the rake face further comprises a third face, which is located closer to the axis than the first face and has a width from the one of the cutting edges increasing as the third face approaches the outer periphery from the axis.

5. The drill according to claim 1, wherein one boundary between the first face and one of the twisted flutes and another boundary between the second face and the one of the twisted flutes are each curved.

6. The drill according to claim 1, wherein a rake angle of the rake face is smaller than a twist angle of a corresponding one of the twisted flutes.

7. A method of cutting a workpiece for boring with the drill according to claim 1, the method comprising:
approaching a drill and a workpiece each other while rotating the drill;
bringing the cutting edges of the drill into contact with a surface of the workpiece, and boring the workpiece; and
separating the workpiece and the drill from each other.
